(19) United States
(12) Patent Application Publication
(10) Pub. No.: US 2024/0407387 A1
(43) Pub. Date: Dec. 12, 2024

(54) CHOCOLATE PRODUCT

(71) Applicant: Kraft Foods Schweiz Holding GmbH, Zug (CH)

(72) Inventors: Katelyn Comerford, East Hanover, NJ (US); Indraneil Mukherjee, East Hanover, NJ (US); Clive Norton, East Hanover, NJ (US)

(21) Appl. No.: 18/694,901

(22) PCT Filed: Sep. 26, 2022
(86) PCT No.: PCT/EP2022/076720

§ 371 Date: Mar. 22, 2024

Related U.S. Application Data
(60) Provisional application No. 63/248,937, filed on Sep. 27, 2021.

(51) Int. Cl. A23G 1/36; A23G 1/00; A23G 1/40

(52) U.S. Cl. CPC A23G 1/36; A23G 1/0006; A23G 1/40

(57) ABSTRACT

The invention provides a chocolate product comprising >18 wt. % natural lipid, >10 wt. % sugar and/or sugar replacer, and >5 wt. % of at least one cocoa ingredient selected from the group comprising: cocoa butter, cocoa liquor, cocoa powder, cocoa pulp, and combinations thereof, wherein at least one of the following conditions is satisfied: a. The product comprises more than 8 wt. % and no more than 9 wt. % saturated fat and ≤2.5 wt. % sugar; b. The product comprises more than 6 wt. % and no more than 8 wt. % saturated fat and ≤4.5 wt. % sugar; c. The product comprises more than 5 wt. % and no more than 6 wt. % saturated fat and ≤9 wt. % sugar; d. The product comprises more than 4 wt. % and no more than 5 wt. % saturated fat and ≤13.5 wt. % sugar; e. The product comprises more than 3 wt. % and no more than 4 wt. % saturated fat and ≤18 wt. % sugar; f. The product comprises more than 2 wt. % and no more than 3 wt. % saturated fat and ≤22.5 wt. % sugar; or g. The product comprises less than or equal to 2 wt. % saturated fat and ≤27 wt. % sugar; and wherein when the product satisfying any of conditions a-g comprises ≤10 wt. % sugar, the remainder of the total combined sugar and sugar replacer content is made up to >10 wt % with sugar replacer.

### TECHNICAL FIELD OF THE INVENTION

The present invention relates to chocolate products and packaged chocolate. The invention also relates to methods of preparing such chocolate products.

### BACKGROUND TO THE INVENTION

Chocolate and chocolate confections are enjoyed by consumers worldwide. However, nutritionally, they are often very energy (calories or joules) dense, offer a high sugar content, and a high saturated fat content. For example, 100 g of a typical milk chocolate can deliver over 500 kcal (2000 kJ) of energy, over 50 g of sugar, and over 18 g of saturated fat.

A number of low-calorie sugar replacement options are commercially available. Whilst there has been progress in the manufacture of chocolate products with reduced sugar, these have often contained high saturated fat contents.

Further reducing saturated fat in chocolate and chocolate confections is a significant challenge. Fats with lower saturation also generally melt at lower temperatures. This makes it difficult to manufacture low saturated fat chocolate products, which are also solid at room temperature, have an authentic chocolate flavour, and which provide a good mouthfeel.

Attempts have been made to achieve such a chocolate product through the incorporation of additional non-chocolate solid inclusions to improve rigidity and mouthfeel. Examples of such solids include wafers, pretzels, nut pieces, and soy protein granules, among others.

It is an even greater challenge to manufacture low saturated fat chocolate products which do not require additional non-chocolate solid inclusions to be added to provide rigidity and improve mouthfeel.

It is an aim of embodiments of the present invention to address these requirements by providing chocolate products which provide one or more of the following advantages:
Have relatively low saturated fat and/or sugar contents.
Have relatively low energy (calorie) contents.
Provide a good mouthfeel.
Provide a melt in the mouth feeling.
Provide an authentic chocolate flavour.
Are solid at room temperature, and preferably at temperatures slightly above room temperature.
Provide a low saturated fat content, good rigidity, and preferably good mouthfeel without requiring the incorporation of non-chocolate solid inclusions.
Avoid the use of large amounts of non-natural, synthetic ingredients.

It is also an aim of embodiments of the invention to overcome or mitigate at least one problem of the prior art, whether expressly described herein or not.

### SUMMARY OF THE INVENTION

According to a first aspect of the invention, there is provided a chocolate product comprising >18 wt. % natural lipid, >10 wt. % sugar and/or sugar replacer, and >5 wt. % of at least one cocoa ingredient selected from the group comprising: cocoa butter, cocoa liquor, cocoa powder, cocoa pulp, and combinations thereof, wherein at least one of the following conditions is satisfied:
a. The product comprises more than 8 wt. % and no more than 9 wt. % saturated fat and ≤2.5 wt. % sugar;
b. The product comprises more than 6 wt % and no more than 8 wt. % saturated fat and ≤4.5 wt. % sugar;
c. The product comprises more than 5 wt % and no more than 6 wt. % saturated fat and ≤9 wt. % sugar;
d. The product comprises more than 4 wt % and no more than 5 wt. % saturated fat and ≤13.5 wt. % sugar;
e. The product comprises more than 3 wt % and no more than 4 wt. % saturated fat and ≤18 wt. % sugar;
f. The product comprises more than 2 wt % and no more than 3 wt. % saturated fat and ≤22.5 wt. % sugar; or
g. The product comprises less than or equal to 2 wt. % saturated fat and ≤27 wt. % sugar;
   with the proviso that when the product satisfying any of conditions a-g comprises <10 wt. % sugar, the remainder of the total combined sugar and sugar replacer content is made up to >10 wt % with sugar replacer.

Such a chocolate product is relatively low in saturated fat, sugar, and energy (calories) compared to typical chocolate. However, it also provides an authentic chocolate flavour, good mouthfeel, and good rigidity without requiring the incorporation of non-chocolate solid inclusions. Further, the above advantages can be achieved without the use of large amounts of non-natural, synthetic ingredients.

By “natural lipid” we mean a lipid that is derived from a natural source, such as a plant, mineral, animal or microbial source.

In some embodiments, at least one cocoa ingredient may contribute to both the total amount of cocoa ingredient in the product and to the total amount of natural lipid in the product. At least one cocoa ingredient of the >5 wt % cocoa ingredient in the product may also contribute to the >18 wt % natural lipid in the product.

In some embodiments the chocolate product is a solid or a paste at ambient pressure up to 25° C., or up to 26, 27, 28, 29, 30, 31, 32, 33, 34, 35, 36, 37, 38, 39 or up to at least 40° C.

Preferably, the chocolate product is a non-powder solid at ambient pressure up to 25° C., or up to 26, 27, 28, 29, 30, 31, 32, 33, 34, 35, 36, 37, 38, 39 or up to at least 40° C.

By “non-powder solid” powder and granules are excluded.

In some embodiments, preferably wherein the chocolate product is a solid or paste at ambient pressure and a temperature as described above, if the product comprises less than or equal to 5 wt % saturated fat, at least one lipid in the product may be a natural wax. In such embodiments, at least 5 wt % of the product may comprise at least one natural wax, or at least 6, 8, 10, 12, 14, 16, or at least 18 wt % of the product may comprise at least one natural wax.

In some embodiments, the chocolate product is a solid moulded chocolate product. The moulded chocolate product may be in the form of a stick, a rod, a tablet, a block, a bar, or shapes such as eggs, animals, stars, Santa, cuboid, spheroid, sphere etc.

In some embodiments the chocolate product may be provided in a form and size intended to provide multiple servings. The multiple serving of the chocolate product may have a weight greater than 30 g, 40 g, 50 g, 60 g, 70 g, 80 g, 90 g, 100 g, 250 g or greater than 500 g. The multiple serving of the chocolate product may be one body. The body of chocolate product may have defined portions intended to be broken or torn off the body of the chocolate product to provide a serving of the product. A suitable form of the body of product may be a tablet, block, or bar. The term “tablet” is known in the art to refer to a substantially planar chocolate product with portions, for example squares, defined by grooves or other break lines or regions in the product.

The chocolate product may be in the form of a shell, sheet, or the like, for example.

In other embodiments, the inventive chocolate product is a chocolate coating, preferably a solid chocolate coating. The inventive chocolate product may coat an edible product.

Another aspect of the invention therefore provides an edible product coated or enrobed with a chocolate product of the first aspect of the invention.

The chocolate product may form a panned coating on the edible product.

The edible product may be a chocolate product or non-chocolate product. Suitable edible products include but are not limited to chocolate products, such as bars, tablets, sticks, rods, etc.; baked or farinaceous products, such as biscuits, cookies, cakes, doughnuts, crackers, wafers, pretzels, cereals, etc.; nuts, such as peanuts, almonds, cashews, hazelnuts, etc.; fruits, which may comprise dried fruits, such as raisins, dates, apricots, cherries, etc; and confectionery products, such as hard candy, jelly candy, chewy candy, toffee, fudge, marshmallow etc. In some embodiments, the edible product may be or comprise a chocolate product of the invention.

In some embodiments, the inventive chocolate product is a filled chocolate product. The filled chocolate product may comprise the inventive chocolate product as a chocolate shell surrounding a filling. In some embodiments, the chocolate shell may assume any shape, such as an egg, animal, star, Santa, lentil, bean, lozenge, cuboid, sphere etc. The filling may be a chocolate or non-chocolate confectionery filling, a farinaceous filling, or the like, for example. Suitable fillings for the chocolate product include but are not limited to fruit juice; fruit puree (coulis); fruit pulp; vegetable pulp; vegetable puree; fruit sauce; fruit syrup; fruit extract; vegetable sauce; honey; caramel; fondant; caramel; ganache; corn syrup; sugar syrup; polyol syrup; hydrogenated starch hydrolysates syrup; emulsions; vegetable oil; glycerin; propylene glycol; chocolate syrup; chocolate sauce; solid chocolate; dairy-based liquids such as milk, cream, yoghurt, etc.; mousse; gel; fondant; jam; fudge; a gelatin-comprising filling; an isomalt-comprising filling; icing sugar; and combinations thereof.

In some embodiments, the inventive chocolate product is a filling within an edible product. Another aspect of the invention is therefore a food product comprising an edible product having filling comprising the chocolate product of the first aspect of the invention. In some embodiments the filling consists of, or consists essentially of, the chocolate product. The edible product may be a chocolate product or a non-chocolate product. The edible product may be a farinaceous product, or a baked farinaceous product. The edible product may include but is not limited to baked products such as cakes, doughnuts, wafers, pastries, tarts, etc. The edible product may be a confectionery product such as hard candy, jelly candy, chewy candy, toffee, fudge, marshmallow etc., that contains a chocolate centre. The chocolate product may be partially or fully surrounded by the edible product. The outer surface area of the chocolate product may be at least 50% surrounded by the edible product, or at least 60, 70, 80, or at least 90%, or substantially 100% of the outer surface area of the chocolate product may be surrounded by the edible product. The edible product may form a layer of even or uneven thickness. In some embodiments, the layer has a thickness of at least 1, 2, 3, 4, or at least 5 mm. The layer may have a thickness of no greater than 10, 9, 8, 7, 6, or no greater than 5 cm.

In some embodiments, the chocolate product is a coated or enrobed chocolate product. The chocolate product may comprise a layer of coating material on a surface of the chocolate product, preferably an outer surface. The chocolate product may comprise a layer of coating material over at least 50% of the outer surface area of the chocolate product, or over at least 60, 70, 80, 90%, or over substantially 100% of the outer surface area of the chocolate product. The coating material may comprise a non-chocolate confectionery material. The coating material may include but is not limited to one or more coating materials selected from the group comprising: frosting; candy; honey; caramel; toffee; fondant; cream; mousse; gel; jam; sugar; sugar alcohol; syrup; and combinations thereof.

The term ‘chocolate’ includes any material that meets a legal definition of chocolate in any jurisdiction. However, the term ‘chocolate’ is not limited to material which meets any legal definition of chocolate and also includes chocolate substitutes and analogues. For instance, ‘chocolate’ herein includes materials in which all or part of the cocoa butter (CB) of legally or regulatory-defined chocolate is replaced by cocoa butter equivalents (CBE), cocoa butter substitutes (CBS), cocoa butter replacers (CBR) and/or other lipids. For example, the term “chocolate” also includes chocolates in which part, or all the cocoa butter has been replaced by vegetable fat. The term ‘compound chocolate’ as used herein means chocolate-like analogues characterized by presence of one or more cocoa solids from any part of the cocoa bean or cocoa pod (which may be one or more selected from the group consisting of cocoa mass, cocoa butter, cocoa powder, cocoa pulp, cocoa husk and cocoa shell,) in any amount.

The term ‘cocoa’, as used in any context throughout this specification, is also taken to include the tautologous terminology ‘cacao’.

The cocoa pulp may be dried cocoa pulp.

The chocolate product may be a non-milk or low milk containing (commonly referred to as plain and/or dark), milk, compound, or white chocolate product. Preferably, the product is a plain, dark or milk chocolate product.

In some embodiments, the plain and/or dark chocolate contains no greater than 10 wt % milk ingredients, or no greater than 9, 8, 7, 6, 5, 4, 3, 2, or no greater than 1 wt % milk ingredients. In preferred embodiments, the plain and/or dark chocolate may contain no or substantially no milk ingredients or may contain milk fat but no other milk solids.

The term “lipid” is defined to include fats; butters; oils; waxes (including E901-E915); mineral oils; emulsifiers; partially saturated or partially hydrogenated fats; monoglycerides; saturated, unsaturated, and partially saturated triglycerides (TAGs) and diglycerides (DAGs); phospholipids; sphingolipids; glycolipids; and olefinic materials.

The term “sugar” refers to a monosaccharide or disaccharide with an energy content of >3 kcal/g. Examples of suitable sugars include glucose, fructose, galactose, sucrose, lactose, maltose, and sugar hydrates (such as dextrose monohydrate, for example), among others.

The term “sugar replacer” is taken to include bulking agents, high potency sweeteners, and protein-based sugar replacers. Bulking agents include but are not limited to monosaccharides or disaccharides having an energy content of ≤3 kcal/g; oligosaccharides; polysaccharides; sugar alcohols (including hydrogenation products of any monosaccharides, disaccharides, and of oligosaccharides/polysaccharides containing 3 or more monosaccharide units); dietary fiber (both insoluble and soluble); grains; cereals; resistant starches and flours containing resistant starches; novel bulking agents (such as powdered insects, algae biomass, upcycled plant material, sea weed, sand, calcium carbonate, and other minerals); and any combinations thereof. In preferred embodiments the bulking agent comprises at least one sugar alcohol and/or dietary fiber.

In some embodiments, the chocolate product contains less than 10 wt % non-chocolate solid inclusions, or less than 9, 8, 7, 6, 5, 4, 3, 2, or less than 1 wt % non-chocolate solid inclusions. In preferred embodiments, the chocolate product contains substantially no non-chocolate solid inclusions. ‘Solid inclusions’ include solid particles which have an average (mean) largest dimension which is larger than average largest dimensions of any bulking agent particles in the chocolate product (such as edible grain powders, for example) The non-chocolate solid inclusions, when present may have an average (mean) largest dimension of greater than 0.6 mm, 0.7 mm 0.8 mm, 0.9 mm or of greater than 1 mm. Examples of non-chocolate solid inclusions include: wafers, pretzels, nut pieces, soy protein granules, biscuits, cereals, and grains. In some embodiments, the chocolate product contains no solid inclusions.

In some embodiments, the chocolate product may comprise less than 3000 kJ of energy per 100 g, or less than 3000, 2990, 2980, 2970, 2960, 2950, 2940, 2930, 2920, 2910, 2900, 2890, 2880, 2870, 2860, 2850, 2840, 2830, 2820, 2810, 2800, 2790, 2780, 2770, 2760, 2750, 2740, 2730, 2720, 2710, 2700, 2690, 2680, 2670, 2660, 2650, 2640, 2630, 2620, 2610, 2600, 2590, 2580, 2570, 2560, 2550, 2540, 2530, 2520, 2510, 2500, 2490, 2480, 2470, 2460, 2450, 2440, 2430, 2420, 2410, 2400, 2390, 2380, 2370, 2360, 2350, 2340, 2330, 2320, 2310, 2300, 2290, 2280, 2270, 2260, 2250, 2240, 2230, 2220, 2210, 2200, 2190, 2180, 2170, 2160, 2150, 2140, 2130, 2120, 2110, 2100, 2090, 2080, 2070, 2060, 2050, 2040, 2030, 2020, 2010, 2000, 1990, 1980, 1970, 1960, 1950, 1940, 1930, 1920, 1910, 1900, 1890, 1880, 1870, 1860, 1850, 1840, 1830, 1820, 1810, 1800, 1790, 1780, 1770, 1760, 1750, 1740, 1730, 1720, 1710, 1700, 1690, 1680, 1670, 1660, 1650, 1640, 1630, 1620, 1610, 1600, 1590, 1580, 1570, 1560, 1550, 1540, 1530, 1520, 1510, 1500, 1490, 1480, 1470, 1460, 1450, 1440, 1430, 1420, 1410, 1400, 1390, 1380, 1370, 1360, 1350, 1340, 1330, 1320, 1310, 1300, 1290, 1280, 1270, 1260, 1250, 1240, 1230, 1220, 1210, or less than 1200 kJ of energy per 100 g.

In some preferred embodiments, the chocolate product satisfies at least one of the following conditions:
a. The product comprises more than 7 wt % and no more than 8 wt % saturated fat and <1340 kJ per 100 g;
b. The product comprises more than 6 wt % and no more than 7 wt % saturated fat and <1675 kJ per 100 g;
c. The product comprises more than 5 wt % and no more than 6 wt % saturated fat and <2010 kJ per 100 g;
d. The product comprises more than 4 wt % and no more than 5 wt % saturated fat and <2345 kJ per 100 g;
e. The product comprises less than or equal to 4 wt % saturated fat and <2680 kJ per 100 g.

The product may comprise more than 7 wt % and no more than 8 wt % saturated fat; and less than 1330 kJ per 100 g, or less than 1320, 1310, 1300, 1290, 1280, 1270, 1260, 1250, 1240, 1230, 1220, 1210, or less than 1200 kJ per 100 g.

The product may comprise more than 6 wt % and no more than 7 wt % saturated fat; and less than 1670 kJ per 100 g, or less than 1660, 1650, 1640, 1630, 1620, 1610, 1600, 1590, 1580, 1570, 1560, 1550, 1540, 1530, 1520, 1510, 1500, 1490, 1480, 1470, 1460, 1450, 1440, 1430, 1420, 1410, 1400, 1390, 1380, 1370, 1360, 1350, 1340, 1330, 1320, 1310, 1300, 1290, 1280, 1270, 1260, 1250, 1240, 1230, 1220, 1210, or less than 1200 kJ per 100 g.

The product may comprise more than 5 wt % and no more than 6 wt % saturated fat; and less than 2000 kJ per 100 g, or less than 1990, 1980, 1970, 1960, 1950, 1940, 1930, 1920, 1910, 1900, 1890, 1880, 1870, 1860, 1850, 1840, 1830, 1820, 1810, 1800, 1790, 1780, 1770, 1760, 1750, 1740, 1730, 1720, 1710, 1700, 1690, 1680, 1670, 1660, 1650, 1640, 1630, 1620, 1610, 1600, 1590, 1580, 1570, 1560, 1550, 1540, 1530, 1520, 1510, 1500, 1490, 1480, 1470, 1460, 1450, 1440, 1430, 1420, 1410, 1400, 1390, 1380, 1370, 1360, 1350, 1340, 1330, 1320, 1310, 1300, 1290, 1280, 1270, 1260, 1250, 1240, 1230, 1220, 1210, or less than 1200 kJ per 100 g.

The product may comprise more than 4 wt % and no more than 5 wt % saturated fat; and less than 2340 kJ per 100 g, or less than 2330, 2320, 2310, 2300, 2290, 2280, 2270, 2260, 2250, 2240, 2230, 2220, 2210, 2200, 2190, 2180, 2170, 2160, 2150, 2140, 2130, 2120, 2110, 2100, 2090, 2080, 2070, 2060, 2050, 2040, 2030, 2020, 2010, 2000, 1990, 1980, 1970, 1960, 1950, 1940, 1930, 1920, 1910, 1900, 1890, 1880, 1870, 1860, 1850, 1840, 1830, 1820, 1810, 1800, 1790, 1780, 1770, 1760, 1750, 1740, 1730, 1720, 1710, 1700, 1690, 1680, 1670, 1660, 1650, 1640, 1630, 1620, 1610, 1600, 1590, 1580, 1570, 1560, 1550, 1540, 1530, 1520, 1510, 1500, 1490, 1480, 1470, 1460, 1450, 1440, 1430, 1420, 1410, 1400, 1390, 1380, 1370, 1360, 1350, 1340, 1330, 1320, 1310, 1300, 1290, 1280, 1270, 1260, 1250, 1240, 1230, 1220, 1210, or less than 1200 kJ per 100 g.

The product may comprise less than or equal to 4 wt % saturated fat; and less than 2670 kJ per 100 g, or less than 2660, 2650, 2640, 2630, 2620, 2610, 2600, 2590, 2580, 2570, 2560, 2550, 2540, 2530, 2520, 2510, 2500, 2490, 2480, 2470, 2460, 2450, 2440, 2430, 2420, 2410, 2400, 2390, 2380, 2370, 2360, 2350, 2340, 2330, 2320, 2310, 2300, 2290, 2280, 2270, 2260, 2250, 2240, 2230, 2220, 2210, 2200, 2190, 2180, 2170, 2160, 2150, 2140, 2130, 2120, 2110, 2100, 2090, 2080, 2070, 2060, 2050, 2040, 2030, 2020, 2010, 2000, 1990, 1980, 1970, 1960, 1950, 1940, 1930, 1920, 1910, 1900, 1890, 1880, 1870, 1860, 1850, 1840, 1830, 1820, 1810, 1800, 1790, 1780, 1770, 1760, 1750, 1740, 1730, 1720, 1710, 1700, 1690, 1680, 1670, 1660, 1650, 1640, 1630, 1620, 1610, 1600, 1590, 1580, 1570, 1560, 1550, 1540, 1530, 1520, 1510, 1500, 1490, 1480, 1470, 1460, 1450, 1440, 1430, 1420, 1410, 1400, 1390, 1380, 1370, 1360, 1350, 1340, 1330, 1320, 1310, 1300, 1290, 1280, 1270, 1260, 1250, 1240, 1230, 1220, 1210, or less than 1200 kJ per 100 g.

In some embodiments, the product comprises less than or equal to 7.9 wt % saturated fat, or less than or equal to 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % saturated fat. In some embodiments, the product comprises substantially no saturated fat.

In some embodiments, the product comprises less than or equal to 26.9 wt % sugar, or less than or equal to 26.8, 26.7, 26.6, 26.5, 26.4, 26.3, 26.2, 26.1, 26, 25.9, 25.8, 25.7, 25.6, 25.5, 25.4, 25.3, 25.2, 25.1, 25, 24.9, 24.8, 24.7, 24.6, 24.5, 24.4, 24.3, 24.2, 24.1, 24, 23.9, 23.8, 23.7, 23.6, 23.5, 23.4, 23.3, 23.2, 23.1, 23, 22.9, 22.8, 22.7, 22.6, 22.5, 22.4, 22.3, 22.2, 22.1, 22, 21.9, 21.8, 21.7, 21.6, 21.5, 21.4, 21.3, 21.2, 21.1, 21, 20.9, 20.8, 20.7, 20.6, 20.5, 20.4, 20.3, 20.2, 20.1, 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % sugar, or 0 wt % sugar.

The product may comprise 6-7 wt % saturated fat and less than or equal to 4.5 wt % sugar.

The product may comprise more than 6 wt % and no more than 8 wt %, or more than 6 wt % and no more than 7 wt % saturated fat; and less than or equal to 4.4 wt % sugar, or less than 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % sugar, or 0 wt % sugar.

The product may comprise more than 5 wt % and no more than 6 wt % saturated fat; and less than or equal to 8.9 wt % sugar, or less than or equal to 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % sugar, or 0 wt % sugar.

The product may comprise more than 4 wt % and no more than 5 wt % saturated fat; and less than or equal to 13.4 wt % sugar, or less than or equal to 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % sugar, or 0 wt % sugar.

The product may comprise more than 3 wt % and no more than 4 wt % saturated fat; and less than or equal to 17.9 wt % sugar, or less than or equal to 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % sugar, or 0 wt % sugar.

The product may comprise more than 2 wt % and no more than 3 wt % saturated fat; and less than or equal to 22.4 wt % sugar, or less than or equal to 22.3, 22.2, 22.1, 22, 21.9, 21.8, 21.7, 21.6, 21.5, 21.4, 21.3, 21.2, 21.1, 21, 20.9, 20.8, 20.7, 20.6, 20.5, 20.4, 20.3, 20.2, 20.1, 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % sugar, or 0 wt % sugar.

The product may comprise less than or equal to 2 wt % saturated fat; and less than or equal to 26.9 wt % sugar, or less than or equal to 26.8, 26.7, 26.6, 26.5, 26.4, 26.3, 26.2, 26.1, 26, 25.9, 25.8, 25.7, 25.6, 25.5, 25.4, 25.3, 25.2, 25.1, 25, 24.9, 24.8, 24.7, 24.6, 24.5, 24.4, 24.3, 24.2, 24.1, 24, 23.9, 23.8, 23.7, 23.6, 23.5, 23.4, 23.3, 23.2, 23.1, 23, 22.9, 22.8, 22.7, 22.6, 22.5, 22.4, 22.3, 22.2, 22.1, 22, 21.9, 21.8, 21.7, 21.6, 21.5, 21.4, 21.3, 21.2, 21.1, 21, 20.9, 20.8, 20.7, 20.6, 20.5, 20.4, 20.3, 20.2, 20.1, 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % sugar, or 0 wt % sugar.

In some embodiments, the chocolate product comprises at least 15 wt % sugar and/or sugar replacer, or at least 20, 25, 30, 35, 40, or at least 45 wt % sugar and/or sugar replacer. In some embodiments, the chocolate product comprises no greater than 95 wt % sugar and/or sugar replacer, or no greater than 90, 85, 80, 75, 70, 65, 60, 55, 50, 45, 40, or no greater than 35 wt % sugar and/or sugar replacer.

In some embodiments, the chocolate product comprises between 20-80 wt % sugar and/or sugar replacer, or between 20-75 wt % sugar and/or sugar replacer.

In some embodiments, the chocolate product comprises at least one sugar replacer independently selected from the group comprising: oligosaccharides; polysaccharides; sugar alcohols; non-nutritive monosaccharides and disaccharides with an energy content of ≤3 kcal/g; dietary fiber (insoluble and soluble); resistant starches and flours containing resistant starches; novel bulking agents (including powdered insects, algae biomass, upcycled plant material, sea weed, sand, calcium carbonate, and other minerals); high potency sweeteners (including artificial sweeteners and non-nutritive natural sweeteners); protein-based sugar replacers; and any combinations thereof, among others.

One or more oligosaccharides may be selected from the group comprising: galactooligosaccharides (GOS), fructooligosaccharides (FOS), isomaltoligosaccharides (IMO), xylooligosaccharides (XOS), raffinoses, cellotriose, xylotriose, kojitriose, human milk oligosaccharides, dextrins, xylodextrins, cellodextrins, partially hydrolysed hemicellulose (including hemicellodextrin), digestion resistant cyclodextrins, and combinations thereof, among others. One or more polysaccharides may be selected from the group comprising: inulins, arabinoxylans, pectins, polyglycitols, resistant starches, starch, celluloses, hemicelluloses, xylan, and combinations thereof, among others. In some embodiments, the product may comprise less than 10 wt % in total of oligosaccharides and polysaccharides, or less than 8, 6, 4, or less than 2 wt % in total of oligosaccharides and polysaccharides. In some embodiments, the product may comprise substantially no oligosaccharides or polysaccharides.

One or more non-nutritive monosaccharides and/or disaccharides may be selected from the group comprising: palatinose, allulose, tagatose, sorbose, cellobiose, xylose, altrose, L-glucose, psicose, and combinations thereof, among others.

One or more dietary fibers may be selected from the group comprising: polydextrose, maltodextrins, vegetable-derived fibers, plant-derived fibers, cellulose-derived fibers, hemicellulose based fibers, resistant dextrins, soluble corn/wheat fiber, inulin, arabinoxylan, polydextrose, oat fiber, wheat fiber, citrus fiber, pea fiber, micro-crystalline cellulose, cocoa pod husk fiber, maple fiber, pecan shell fiber, brewers spent grain powder, psyllium husk fiber, beta glucan, and combinations thereof, among others.

One or more resistant starches and/or flours containing resistant starches may be selected from the group comprising: natural high amylose corn/wheat/barley/rice/potato starch (RS2); high amylose corn/wheat/rice flour (RS2); modified starches from various sources (RS4); brans such as corn, oat, rice, wheat and barley bran; and combinations thereof, among others.

In some embodiments, the chocolate product comprises at least 0.01 wt % dietary fiber, or at least 0.02, 0.03, 0.04, 0.05, 0.06, 0.07, 0.08, 0.09, 0.1, 0.2, 0.3, 0.4, 0.5, 0.6, 0.7, 0.8, 0.9, or at least 1 wt % dietary fiber. In some embodiments, the product comprises less than 20 wt % dietary fiber, or less than 19, 18, 17, 16, 15, 14, 13, 12, 11, or preferably less than 10 wt % dietary fiber. In some embodiments, between 30-70% of the total dietary fiber content of the chocolate product is vegetable-derived fiber, and preferably potato fiber, or between 40-65%, or between 50-60% of the total dietary fiber content is vegetable-derived, and preferably potato fiber.

High potency sweeteners may comprise artificial sweeteners and/or non-nutritive natural sweeteners.

Artificial sweeteners may be selected from the group comprising: acesulfame K, advantame, alitame, aspartame, aspartame-acesulfame salt, cyclomates, glucin, neohespiridin dihydrochalcone, neotame, saccharin, sucralose, rebaudioside A, rebaudioside D, rebaudioside M and combinations thereof.

Non-nutritive natural sweeteners may be selected from the group comprising: glycyrrhizin, monatin, osladine, stevia, steviol glycosides, monk fruit, mogrosides, and combinations thereof.

In some embodiments, the at least one sugar replacer comprises at least one sugar alcohol. The at least one sugar alcohol may be independently selected from the group comprising: erythritol, maltitol, mannitol, sorbitol, xylitol, arabitol, sorbitol, glycerol, hydrogenated starch hydrosylates (HSH), isomalt, lactitol, and combinations thereof. In some embodiments, the at least one sugar replacer consists only of sugar alcohols. In some preferred embodiments, the at least one sugar alcohol comprises maltitol and/or erythritol. The product may comprise a single sugar alcohol, which may be maltitol or erythritol. The product may comprise the single sugar alcohol in an amount of between 5-70 wt %, or between 8-65 wt %, or between 10-60 wt %.

In some embodiments, the product comprises two or more different sugar alcohols. The product may comprise 2, 3, 4, 5, 6, 7, 8, 9, or 10 different sugar alcohols.

In some preferred embodiments, the product comprises maltitol and erythritol. The product may comprise more maltitol than erythritol. The product may comprise between 10-45 wt % of maltitol and between 5-20 wt % of erythritol; or preferably between 15-40 wt % of maltitol and between 7-15 wt % of erythritol; or more preferably between 18-38 wt % of maltitol and between 8-14 wt % of erythritol.

The chocolate product may comprise the at least one sugar replacer in an amount of at least 1 wt %, or in an amount of at least 2, 3, 4, 5, 6, 7, 8, 9, 10, 11, 12, 13, 14, 15, 16, 17, 18, 19, or in an amount of at least 20 wt %.

The chocolate product may comprise the at least one sugar replacer in an amount of no greater than 70 wt %, or of no greater than 69, 68, 67, 66, 65, 64, 63, 62, 61, 60, 59, 58, 57, 56, 55, 54, 53, 52, 51, or of no greater than 50 wt %.

In some embodiments, the chocolate product comprises the at least one sugar replacer in an amount of between 10-50 wt %.

The at least one sugar replacer may be present in an amount of between 10-48 wt %, or of between 10-46, 10-44, 10-42, 10-40, 10-38, 10-36, 10-34, 10-32, 10-30, 10-28, 10-26, 10-24, 10-22, 10-20, 10-18, 10-16, 10-14, or of between 10-12 wt %.

The at least one sugar replacer may be present in an amount of between 12-50 wt %, or of between 14-50, 16-50, 18-50, 20-50, 22-50, 24-50, 26-50, 28-50, 30-50, 32-50, 34-50, 36-50, 38-50, 40-50, 42-50, 44-50, 46-50, or of between 48-50 wt %.

The at least one sugar replacer may be present in an amount of between 12-48 wt %, or of between 14-48, 16-48, 18-48, 20-48, 22-48, 24-48, 26-48, 28-48, 30-48, 32-48, 34-48, 36-48, 38-48, 40-48, 42-48, 44-48, 46-48, 12-46, 14-46, 16-46, 18-46, 20-46, 22-46, 24-46, 26-46, 28-46, 30-46, 32-46, 34-46, 36-46, 38-46, 40-46, 42-46, 44-46, 12-44, 14-44, 16-44, 18-44, 20-44, 22-44, 24-44, 26-44, 28-44, 30-44, 32-44, 34-44, 36-44, 38-44, 40-44, 42-44, 12-42, 14-42, 16-42, 18-42, 20-42, 22-42, 24-42, 26-42, 28-42, 30-42, 32-42, 34-42, 36-42, 38-42, 40-42, 12-40, 14-40, 16-40, 18-40, 20-40, 22-40, 24-40, 26-40, 28-40, 30-40, 32-40, 34-40, 36-40, 38-40, 12-38, 14-38, 16-38, 18-38, 20-38, 22-38, 24-38, 26-38, 28-38, 30-38, 32-38, 34-38, 36-38, 12-36, 14-36, 16-36, 18-36, 20-36, 22-36, 24-36, 26-36, 28-36, 30-36, 32-36, 34-36, 12-34, 14-34, 16-34, 18-34, 20-34, 22-34, 24-34, 26-34, 28-34, 30-34, 32-34, 12-32, 14-32, 16-32, 18-32, 20-32, 22-32, 24-32, 26-32, 28-32, 30-32, 12-30, 14-30, 16-30, 18-30, 20-30, 22-30, 24-30, 26-30, 28-30, 12-28, 14-28, 16-28, 18-28, 20-28, 22-28, 24-28, 26-28, 12-26, 14-26, 16-26, 18-26, 20-26, 22-26, 24-26, 12-24, 14-24, 16-24, 18-24, 20-24, 22-24, 12-22, 14-22, 16-22, 18-22, 20-22, 12-20, 14-20, 16-20, 18-20, 12-18, 14-18, 16-18, 12-16, 14-16, 12-14.

The above statements relating to the amount of sugar replacer may also be applied to the total amount of sugar alcohol in the chocolate product.

In some embodiments the ratio of the amount of sugar replacer to sugar is at least 0.5, or at least 1, 2, 3, 4, 5, 6, 7, 8, 9, 10, 15, 20, 25, 30, 35, 40, 45, 50, 55, 60, 65, 70, or at least 75.

In some embodiments, the ratio of the amount of sugar replacer to sugar is no greater than 500, or no greater than 450, 400, 350, 300, 250, 200, 150, 100, 90, 80, 70, 60, 50, 40, 30, 20, 10, 9, 8, 7, 6, 5, 4, 3, 2, or no greater than 1.

In some embodiments, the ratio of the amount of sugar replacer to sugar is between 0.5-100, or between 5-95, or between 15-90.

The ratio of the amount of sugar replacer to sugar may be between 15-85, or between 15-80, 15-75, 15-70, 15-65, 15-60, 15-55, 15-50, 15-45, 15-40, 15-35, 15-30, 15-25, or between 15-20.

The ratio of the amount of sugar replacer to sugar may be between 20-90, or between 25-90, 30-90, 35, 90, 40-90, 45-90, 50-90, 55-90, 60-90, 65-90, 70-90, 75-90, 80-90, or between 85-90.

The ratio of the amount of sugar replacer to sugar may be between 20-85, or between 25-85, 30-85, 35-85, 40-85, 45-85, 50-85, 55-85, 60-85, 65-85, 70-85, 75-85, 80-85, 20-80, 25-80, 30-80, 35-80, 40-80, 45-80, 50-80, 55-80, 60-80, 65-80, 70-80, 75-80, 20-75, 25-75, 30-75, 35-75, 40-75, 45-75, 50-75, 55-75, 60-75, 65-75, 70-75, 20-70, 25-70, 30-70, 35-70, 40-70, 45-70, 50-70, 55-70, 60-70, 65-70, 20-65, 25-65, 30-65, 35-65, 40-65, 45-65, 50-65, 55-65, 60-65, 20-60, 25-60, 30-60, 35-60, 40-60, 45-60, 50-60, 55-60, 20-55, 25-55, 30-55, 35-55, 40-55, 45-55, 50-55, 20-50, 25-50, 30-50, 35-50, 40-50, 45-50, 20-45, 25-45, 30-45, 35-45, 40-45, 20-40, 25-40, 30-40, 35-40, 20-35, 25-35, 30-35, 20-30, 25-30, or between 20-25.

In some embodiments, the chocolate product comprises at least 19 wt % lipid, or at least 19.5, 20, 21, 22, 23, 24, 25, 26, 27, 28, 29, or at least 30 wt % lipid. In some embodiments, the chocolate product comprises no greater than 80 wt % lipid, or no greater than 75, 70, 65, 60, 55, 50, 45, 40, or no greater than 35 wt % lipid.

In some embodiments, the chocolate product comprises between 22-40 wt % lipid, or between 23-37 wt % lipid, or between 24-35 wt % lipid, or between 24-32 wt % lipid.

In some embodiments, the chocolate product comprises at least 19 wt % natural lipid, or at least 19.5, 20, 21, 22, 23, 24, 25, 26, 27, 28, 29, or at least 30 wt % natural lipid.

In some embodiments, the chocolate product comprises no greater than 80 wt % natural lipid, or no greater than 75, 70, 65, 60, 55, 50, 45, 40, or no greater than 35 wt % natural lipid.

In some embodiments, the chocolate product comprises between 18-40 wt % natural lipid, or between 18-35 wt % natural lipid, or between 18-30 wt % natural lipid, or between 18-25 wt % natural lipid.

In some embodiments, at least 50 wt % of the total lipid in the product is natural lipid, or at least 60, 70, 80, 90, 95, 96, 97, 98, or at least 99 wt % of the total lipid in the product is natural lipid. In some embodiments, substantially 100% of the total lipid in the product is natural lipid.

In some embodiments, the product comprises at least one natural lipid ingredient independently selected from the group comprising: cocoa butter, a nut butter, a seed butter, a nut oil, a seed oil, and combinations thereof.

References to nut and seed butters throughout the specification also include nut and seed pastes.

In some embodiments, at least 50 wt % of the total natural lipid in the product is derived from at least one natural lipid ingredient independently selected from the group comprising: cocoa butter, a nut butter, a seed butter, a nut oil, a seed oil, and combinations thereof, or at least 60, 70, 80, 90, 95, 96, 97, 98, or at least 99 wt % of the total natural lipid in the product is derived from at least one natural lipid ingredient independently selected from the group comprising: cocoa butter, a nut butter, a seed butter, a nut oil, a seed oil, and combinations thereof. In some embodiments, substantially 100% of the total natural lipid in the product is derived from at least one natural lipid ingredient independently selected from the group comprising: cocoa butter, a nut butter, a seed butter, a nut oil, a seed oil, and combinations thereof.

In some embodiments, at least 50 wt % of the total lipid in the product is derived from at least one natural lipid ingredient independently selected from the group comprising: cocoa butter, a nut butter, a seed butter, a nut oil, a seed oil, and combinations thereof, or at least 60, 70, 80, 90, 95, 96, 97, 98, or at least 99 wt % of the total lipid in the product is derived from at least one natural lipid ingredient independently selected from the group comprising: cocoa butter, a nut butter, a seed butter, a nut oil, a seed oil, and combinations thereof. In some embodiments, substantially 100% of the total lipid in the product is derived from at least one natural lipid ingredient independently selected from the group comprising: cocoa butter, a nut butter, a seed butter, a nut oil, a seed oil, and combinations thereof.

In some embodiments, at least one natural lipid ingredient is cocoa butter. The product may comprise cocoa butter that is derived from at least one cocoa ingredient independently selected from the group comprising: cocoa mass, cocoa liquor, cocoa powder, and combinations thereof.

In some embodiments, the product comprises at least one natural lipid ingredient independently selected from the group comprising: a nut butter, a seed butter, a nut oil, a seed oil, and combinations thereof.

In some embodiments, at least one natural lipid is a natural wax. The product may comprise at least one natural wax that is independently selected from the group comprising: E901 (beeswax), E902 (candelilla wax), E903 (carnauba wax), E904 (shellac), E908 (rice bran wax), E913 (lanolin, sheep wool grease), and combinations thereof.

In some embodiments, the product may comprise at least 1 wt % natural wax, or at least 2, 3, 4, 5, 6, 7, 8, 9, 10, 11, 12, 13, 14, 15, 16, 17, or at least 18 wt % natural wax.

In embodiments wherein the product comprises greater than 5 wt % saturated fat, no greater than 60 wt % of the total amount of natural lipid in the product may be natural wax, or no greater than 50, 40, 30, 20, 10, or no greater than 5 wt % of the total amount of natural lipid in the product may be natural wax, or substantially 0 wt % of the total amount of natural lipid in the product may be natural wax.

In embodiments wherein the product comprises less than or equal to 5 wt % saturated fat, at least 10 wt % of the total amount of natural lipid in the product may be natural wax, or at least 20, 30, 40, 50, 60, 70, 80, 90, or at least 95 wt % of the total amount of natural lipid in the product may be natural wax, or substantially 100 wt % of the total amount of natural lipid in the product may be natural wax.

Each nut or seed butter may be selected from the group comprising: cashew butter, coconut butter, peanut butter, hazelnut butter, soy nut butter, tahini, walnut butter, pistachio butter, Brazil nut butter, macadamia nut butter, pecan butter, chestnut butter, pine nut butter, acorn butter, pumpkin seed butter, sesame seed butter, watermelon seed butter, almond butter, sunflower seed butter, shea butter, sacha inchi butter, macambo butter, sal butter, mango butter, illipe butter, kokum butter, pili nut butter, carob butter, ucuuba butter, cupuaçu butter, bacuri butter, kpangnan butter, murumuru butter, tucuma butter, shea nilotica butter, kombo butter, and combinations thereof. The nut or seed butter may comprise a butter of any edible nut and/or seed. The butter may comprise a paste of ground nuts and/or seeds. The butter may optionally comprise additional oils, fats, and/or other materials.

Similarly, the nut or seed oil may comprise an oil of any edible nut and/or seed. In some embodiments, each nut or seed oil may be independently selected from the group comprising oils of the seeds and nuts stated above for nut or seed butters.

In some embodiments, the product comprises at least 1 wt % of at least one natural lipid ingredient selected from the group comprising: cocoa butter, a nut butter, a seed butter, a nut oil, a seed oil, and combinations thereof; or at least 2 wt %, 3, 4, 5, 6, 7, 8, 9, or at least 10, 15, or at least 20 wt % of at least one natural lipid ingredient selected from the group comprising: cocoa butter, a nut butter, a seed butter, a nut oil, a seed oil, and combinations thereof.

In some embodiments, the product comprises no greater than 70 wt % of at least one natural lipid ingredient selected from the group comprising: cocoa butter, a nut butter, a seed butter, a nut oil, a seed oil, and combinations thereof; or no greater than 69 wt %, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, or no greater than 25 wt % of at least one natural lipid ingredient selected from the group comprising: cocoa butter, a nut butter, a seed butter, a nut oil, a seed oil, and combinations thereof.

In some embodiments, the product comprises between 18-40 wt % of at least one natural lipid ingredient selected from the group comprising: cocoa butter, a nut butter, a seed butter, a nut oil, a seed oil, and combinations thereof, or between 18-35 wt % of at least one natural lipid ingredient selected from the group comprising: cocoa butter, a nut butter, a seed butter, a nut oil, a seed oil, and combinations thereof, or between 18-30 wt % of at least one natural lipid ingredient selected from the group comprising: cocoa butter, a nut butter, a seed butter, a nut oil, a seed oil, and combinations thereof, or between 18-25 wt % of at least one natural lipid ingredient selected from the group comprising: cocoa butter, a nut butter, a seed butter, a nut oil, a seed oil, and combinations thereof.

In some embodiments, the product comprises between 8-28 wt %, or between 8-26, 8-24, 8-22, 8-20, 8-18, 8-16, 8-14, 8-12, or between 8-10 wt % of at least one natural lipid ingredient selected from the group comprising: cocoa butter, a nut butter, a seed butter, a nut oil, a seed oil, and combinations thereof.

In some embodiments, the product comprises between 10-30 wt %, or between 12-30, 14-30, 16-30, 18-30, 20-30, 22-30, 24-30, 26-30, or between 28-30 wt % of at least one natural lipid ingredient selected from the group comprising: cocoa butter, a nut butter, a seed butter, a nut oil, a seed oil, and combinations thereof.

In some embodiments, the product comprises between 12-28 wt %, or between 14-28, 16-28, 18-28, 20-28, 22-28, 24-28, 26-28, 12-26, 14-26, 16-26, 18-26, 20-26, 22-26, 24-26, 12-24, 14-24, 16-24, 18-24, 20-24, 22-24, 12-22, 14-22, 16-22, 18-22, 20-22, 12-20, 14-20, 16-20, 18-20, 12-18, 14-18, 16-18, 12-16, 14-16, or between 12-14 wt % of at least one natural lipid ingredient selected from the group comprising: cocoa butter, a nut butter, a seed butter, a nut oil, a seed oil, and combinations thereof.

In embodiments wherein the product comprises at least 5 wt % saturated fat, at least 30 wt % of the total amount of natural lipid in the product may be independently selected from the group comprising: cocoa butter, a nut butter, a seed butter, a nut oil, a seed oil, and combinations thereof, or at least 40, 50, 60, 70, 80, 90, or at least 95 wt %, or substantially 100 wt % of the total amount of natural lipid in the product may be independently selected from the group comprising: cocoa butter, a nut butter, a seed butter, a nut oil, a seed oil, and combinations thereof.

In some embodiments, the product comprises at least one of: a nut butter, a seed butter, a nut oil, a seed oil, and combinations thereof in a total amount of at least 0.01 wt %, or at least 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, or at least 10 wt %.

In some embodiments, the product comprises at least one of: a nut butter, a seed butter, a nut oil, a seed oil, and combinations thereof in a total amount of no greater than 50 wt %, or no greater than 49, 48, 47, 46, 45, 44, 43, 42, 41, 40, 39, 38, 37, 36, 35, 34, 33, 32, 31, 30, 29, 28, 27, 26, 25, 24, 23, or no greater than 22 wt %.

The product may preferably comprise at least one of: a nut butter, a seed butter, a nut oil, a seed oil, and combinations thereof in a total amount of between 0.2-25 wt %, or between 0.4-22 wt %.

The product may comprise at least one of: a nut butter, a seed butter, a nut oil, a seed oil, and combinations thereof in a total amount of between 0.2-20 wt %, or of between 0.2-15, 0.2-10, 0.2-5, 0.2-1, or of between 0.2-0.5 wt %.

The product may comprise at least one of: a nut butter, a seed butter, a nut oil, a seed oil, and combinations thereof in a total amount of between 0.5-25 wt %, or of between 1-25, 5-25, 10-25, 15-25, or of between 20-25 wt %.

The product may comprise at least one of: a nut butter, a seed butter, a nut oil, a seed oil, and combinations thereof in a total amount of between 0.5-20 wt %, or of between 1-20, 5-20, 10-20, 15-20, 0.5-15, 1-15, 5-15, 10-15, 0.5-10, 1-10, 5-10, 0.5-5, 1-5, or of between 0.5-1 wt %.

The chocolate product may comprise at least one emulsifier. The product may comprise at least one emulsifier independently selected from the group comprising: lecithin derived from soya bean, safflower, corn etc., fractionated lecithins enriched with either phosphatidyl choline, phosphatidyl ethanolamine, phosphatidyl inositol; emulsifiers derived from oats, mono- and diglycerides and their tartaric esters, monosodium phosphate derivatives of mono- and diglycerides of edible fats and oils, sorbitan monostearate, polyoxyethylene sorbitan monostearate, hydroxylated lecithin, synthetic phospholipids such as ammonium phosphatides, poly glycerol polyricinoleate (PGPR), lactylated fatty acid esters of glycerol and propylene glycol, poly glycerol esters of fatty acids, citric acid esters of fatty acids, propylene glycol mono- and diesters of fats and fatty acids, and combinations thereof. In certain embodiments, the product may comprise at least one emulsifier selected from: soya lecithin, and synthetic phospholipids such as ammonium phosphatides or polyglycerol polyricinoleate (PGPR).

Addition of at least one emulsifier to the product allows for easier modification of and better control over the rheology of the chocolate product. The emulsifier may act as a rheology modifier.

In some embodiments, the chocolate product comprises at least 6 wt %, or at least 7, 8, 9, 10, 11, 12, 13, 14, 15, 16, 17, 18, 19, 20, 21, 22, 23, 24, 25, 26, 27, 28, 29, or at least 30 wt % of the least one cocoa ingredient selected from the group comprising: cocoa butter, cocoa liquor, cocoa pulp, cocoa powder, and combinations thereof. In some embodiments, the product comprises no greater than 80 wt % of the at least one cocoa ingredient, or no greater than 75, 70, 65, 60, 55, 50, 45, 40, 35, 30, or no greater than 25 wt % of the at least one cocoa ingredient. In some preferred embodiments, the product comprises between 5-50 wt %, or between 5-45 wt % of the at least one cocoa ingredient.

In some embodiments, the chocolate product further comprises a cocoa butter replacer (CBR). CBRs are non-tempering, non-lauric fats differing in composition from cocoa butter. CBRs are produced by fractionation and hydrogenation of oils rich in C16 and C18 fatty acids, forming trans acids, which increases the solid phase of the fat. Suitable sources for CBR include soya, cottonseed, peanut, rapeseed and corn (maize) oil.

In some embodiments, the chocolate product comprises a cocoa butter extender (CBE). CBEs are defined in Directive 2000/36/EC as complying with the following criteria:
a) they are non-lauric vegetable fats, which are rich in symmetrical monounsaturated triglycerides of the type POP (dipalmitoyl-2-oleoyl glycerol), POSt (1-palmitoyl-2-oleoyl-3-palmitoyl-glycerol) and StOSt (distearoyl-2-oleoyl glycerol);
b) they are miscible in any proportion with cocoa butter, and are compatible with its physical properties (melting point and crystallisation temperature, melting rate, need for tempering phase);
c) they are obtained only by the processes of refining and/or fractionation, which excludes enzymatic modification of the triglyceride structure.

Suitable CBEs include illipe, Borneo tallow, tengkawang, palm oil, sal, shea, kokum gurgi and mango kernel.

In some embodiments, the chocolate product comprises 5 or fewer cocoa ingredients, or 4 or fewer, or 3 or fewer, or 2 or fewer cocoa ingredients. In some preferred embodiments, the chocolate product comprises a single cocoa ingredient. Each cocoa ingredient may be independently selected from the group comprising: cocoa liquor, cocoa powder, cocoa butter and cocoa mass. In some preferred embodiments, the product comprises cocoa liquor as the only cocoa ingredient.

In some embodiments, the product comprises chocolate chips, which may provide the or each cocoa ingredient. The chocolate chips may comprise one or more cocoa ingredients selected from the group comprising: cocoa butter, cocoa liquor, cocoa powder, cocoa mass, and combinations thereof. The chocolate chips may comprise 5 or fewer cocoa ingredients, or 4 or fewer, or 3 or fewer, or 2 or fewer cocoa ingredients, or a single cocoa-ingredient. In some preferred embodiments, the chocolate chips contain only 2 cocoa ingredients, which may comprise cocoa butter and one further ingredient selected from: cocoa liquor, cocoa powder, and cocoa mass. In some embodiments, at least 50% of the cocoa content of the product is provided by the chocolate chips, or at least 60, 70, 80, or at least 90% of the cocoa content of the product is provided by the chocolate chips. In some embodiments, substantially the entire cocoa content of the product is provided by the chocolate chips.

In some embodiments, the product comprises in total less than or equal to 40 wt %, or less than or equal to 35, 30, 25, or preferably less than or equal to 20 wt %, or 18 wt %, or less than or equal to 17 wt % of the following cocoa ingredients: cocoa butter, cocoa liquor, and cocoa powder.

The chocolate product may comprise one or more further cocoa ingredients selected from the group consisting of: cocoa bark, cocoa stem, cocoa leaf, cocoa root and cocoa flower, or extracts or combinations thereof.

In some embodiments, the chocolate product comprises at least 0.5 wt % protein, or at least 1, 1.5, 2, 2.5, 3, 3.5, 4, 4.5, 5, 5.5, 6, 6.5, 7, 7.5, or at least 8 wt % protein. In some embodiments, the product comprises no greater than 30 wt % protein, or no greater than 29, 28, 27, 26, 25, 24, 23, 22, 21, 20, 19, or no greater than 18 wt % protein.

In preferred embodiments, the product comprises 8-20 wt %, or 10-20 wt %, or 8-18 wt %, or 10-18 wt % protein.

The chocolate product may contain high protein ingredients which may contain at least 40 wt % protein. Suitable high protein ingredients include caseins (including αs1-casein, αs2-casein, β-casein, and κ-casein), whey proteins (including whey protein concentrate, whey protein isolate and whey protein hydrolysate), sweet whey, milk protein, pea protein, soy protein, oat protein, algal protein, microbial proteins (such as Solein (RTM)), and combinations thereof. In some embodiments, the chocolate composition comprises milk protein and/or whey protein isolate.

According to a second aspect of the invention there is provided a packaged chocolate product comprising >18 wt. % natural lipid, >10 wt. % sugar and/or sugar replacer, and >5 wt. % of at least one cocoa ingredient selected from the group comprising: cocoa butter, cocoa liquor, cocoa pulp, cocoa powder, and combinations thereof, wherein at least one of the following conditions is satisfied:
a. The product comprises more than 8 wt. % and no more than 9 wt. % saturated fat and ≤2.5 wt. % sugar;
b. The product comprises more than 6 wt % and no more than 8 wt. % saturated fat and ≤4.5 wt. % sugar;
c. The product comprises more than 5 wt % and no more than 6 wt. % saturated fat and ≤9 wt. % sugar;
d. The product comprises more than 4 wt % and no more than 5 wt. % saturated fat and ≤13.5 wt. % sugar;
e. The product comprises more than 3 wt % and no more than 4 wt. % saturated fat and ≤18 wt. % sugar;
f. The product comprises more than 2 wt % and no more than 3 wt. % saturated fat and ≤22.5 wt. % sugar; or
g. The product comprises less than or equal to 2 wt. % saturated fat and ≤27 wt. % sugar;
   with the proviso that when the product satisfying any of conditions a-g comprises <10 wt. % sugar, the remainder of the total combined sugar and sugar replacer content is made up to >10 wt % with sugar replacer.

The chocolate product may be packaged in any suitable packaging material, which may in some embodiments be any one or more materials independently selected from the group comprising cardboard, paper, paperboard, flow-wrap plastics, metal foil, plastics foil and combinations and laminates thereof.

The packaged chocolate product may comprise the chocolate product of the first aspect of the invention. Statements of invention relating to the chocolate product of the first aspect of the invention may also be applied to the second aspect of the invention.

Suitable packaging for the chocolate product may be reclosable or not reclosable (or resealable or not resealable) as known to a person skilled in the art.

The packaged chocolate product may be provided in a form and size intended for a single serving.

A single serving may have a weight in the range of from 10 g to 200 g.

In some embodiments the packaged chocolate product may be provided in a form and size intended to provide multiple servings. The multiple serving of the chocolate product may have a weight greater than 30 g, 40 g, 50 g, 60 g, 70 g, 80 g, 90 g, 100 g, 250 g or greater than 500 g. The multiple serving of the chocolate product may comprise a single body. The single body of chocolate product may have defined portions intended to be broken or torn off the body of the chocolate product to provide a serving of the product. A suitable form of the one body of edible product may be a tablet, block, or bar

In some embodiments, a multiple serving of the chocolate product may be provided as individual pieces. Suitably, the bite-size pieces may have a weight in the range of from 1 g to 30g. The bite-size pieces may be individually wrapped. Alternatively, the bite-size pieces may not be individually wrapped. A plurality of bite-size pieces may be contained in a suitable container. The container may be reclosable and/or resealable.

According to a third aspect of the invention, there is provided a method of preparing the chocolate product of the first aspect of the invention, the method comprising the step of combining >18 wt % natural lipid, >10 wt % sugar and/or sugar replacer, and >5 wt % of at least one cocoa ingredient selected from the group comprising: cocoa butter, cocoa liquor, cocoa powder, cocoa pulp, and combinations thereof.

Statements of invention relating to the chocolate product of the first aspect of the invention may also be applied to the third aspect of the invention.

The method may comprise a step of moulding or extruding the chocolate product to form a bar or block, after combining the ingredients. Preferably, the method may comprise moulding the chocolate product to form a solid bar or block.

The method may include any one or more of size-reducing, refining, conching, tempering and pasting the chocolate product, or ingredients thereof, as is customary in the art of chocolate-making.

The method may comprise packaging the chocolate product to produce the packaged chocolate product of the second aspect of the invention. Statements of invention above relating to the packaged chocolate product of the second aspect of the invention may also be applied to the third aspect of the invention.

According to another aspect of the invention there is provided a method of providing a filled or coated edible product, in which an edible product is filled or coated with a chocolate product of the first aspect of the invention.

In some embodiments, the inventive chocolate product is applied to an edible product as a coating. In some embodiments, the chocolate product is applied as a molten coating and solidified. The edible product may be a chocolate product or non-chocolate product. Edible products include but are not limited to those listed for the first aspect of the invention.

Any suitable method of coating known to those skilled in the art may be employed. Such a method may provide a layer of the inventive chocolate product on a surface of the edible product. The surface may comprise an outer surface of the edible product. The method may comprise coating a layer of the inventive chocolate product on at least 50% of the outer surface area of the edible product, or on at least 60, 70, 80, 90%, or on substantially 100% of the outer surface area of the edible product.

In some embodiments, the method comprises enrobing the edible product with the inventive chocolate product. The method may comprise passing the edible product through a curtain or stream of the inventive chocolate product. The curtain or stream may be formed by molten inventive chocolate product falling from an elevated position relative to the edible product. The molten inventive chocolate product may fall from an elevated trough or like device fed from a suitable container.

In some embodiments, the method comprises dipping the edible product into the molten inventive chocolate product. Suitable methods of dipping include hand-dipping and dipping the edible product using suitable machinery known in the art.

In some embodiments, the method comprises pan coating the edible product with the inventive chocolate product. Pan coating is known to those skilled in the art and makes use of rotating drums to coat the edible product with a chocolate coating. The pan coating method may include but is not limited to one or more of: spray pan coating, ladling, and drip-feeding.

In some embodiments, the method comprises providing a filled chocolate product comprising the inventive chocolate product as a chocolate shell or layer surrounding a filling of edible product. The method may comprise the steps of: providing a shell of the chocolate product and providing a filling, depositing the filling into the chocolate shell, and optionally sealing the chocolate shell. Chocolate shells any suitable shape may be provided, such as eggs, animals, stars, Santa, etc. Suitable fillings include but are not limited to the fillings listed for the first aspect of the invention.

In some embodiments, the chocolate product shell is provided as two complementary fitting sections. The complementary fitting sections of the shell may be attachable to each other to provide a sealed chocolate shell defining an internal cavity capable of containing the filling. At least one or both complementary fitting sections of the shell may define their own cavity into which a filling may be independently deposited before attaching the sections to each other to provide the sealed chocolate shell. The filling in each section may be the same or different. In some embodiments, only one of the two complementary fitting sections of the shell defines its own cavity, and the other section is in the form of a flat or substantially flat chocolate backing.

In some embodiments, the step of providing the chocolate shell comprises forming a first section of the shell in a mould cavity. In such embodiments, the first section defines a cavity in the shape of the mould cavity and into which the filling may be deposited. Moulds may preferably be selected to match the shapes and/or sizes of the chocolate product as detailed in the first aspect of the invention. The step of sealing the chocolate shell may comprise applying a chocolate backing over the first section of the shell and over the filling contained in the first section to seal the shell with the filling enclosed within.

The step of sealing the chocolate shell by attaching two complementary fitting sections of the shell to each other may employ any suitable method known to those skilled in the art. Examples of suitable methods include but are not limited to gluing the sections to each other using an edible glue or applying heat to the points of contact of the two sections to facilitate sealing.

In some embodiments, the method comprises filling an edible product with the prepared inventive chocolate product. Any suitable method of filling known to those skilled in the art may be employed. The edible product may include but is not limited to the edible products described in the first aspect of the invention, especially confectionery and farinaceous or baked products. The edible product may be provided in the form of one or more shells, as described hereinabove for embodiments in which the chocolate product is provided as one or more shells. In some embodiments, the chocolate product, in molten or paste form, may be extruded, injected, or otherwise deposited into a cavity formed in the edible product, and optionally solidified thereafter.

The filled or coated edible product may be packaged, as described hereinabove for other aspects of the invention.

### DETAILED DESCRIPTION OF THE INVENTION

In order that the invention may be more clearly understood embodiments thereof will now be described, by way of example only:

### Inventive Chocolate Products

The following chocolate products of the invention were prepared. Ingredients were mixed using standard chocolate making techniques and the molten chocolate product deposited into moulds and solidified.

All prepared chocolate products were solid bars at room temperature and ambient pressure. The chocolate products were low in saturated fat, sugar, and energy (calories). Products provided an authentic chocolate flavour, good mouthfeel, and good rigidity without the need for non-chocolate solid inclusions to be added, which was surprising given the low concentration of saturated fat. The solid bars also had a desirable glossy, chocolate-like appearance, and they could be snapped/portioned to provide smaller servings of the chocolate product.

The physical form and appearance of the chocolate products were monitored over a period of 2 months from their preparation and were not found to substantially change throughout this period. Surprisingly, given the low saturated fat content, and non-traditional lipid concentrations and makeup, the glossy, chocolate-like appearance and rigidity of the chocolate products remained.

### Example 1: Dark Confectionery Bar

The ingredients are detailed in Table 1 below.

TABLE 1

| | Ingredient values | | | | | | |
|---|---|---|---|---|---|---|---|
| | Lipid | Sat. fat | Sugar | Dietary | Energy | Protein | % ingredient |
| Ingredient | % | % | % | fiber % | (kcal/g) | % | in product |
| Erythritol | | | | | 0.00 | | 57.3% |
| Almond | 53.12% | 4.69% | 6.25% | 9.40% | 5.94 | 22% | 22.0% |
| Butter | | | | | | | |
| CL—Cocoa | 53.50% | 32.10% | 0.30% | 18.80% | 5.10 | 24% | 20.3% |
| Liquor (BarryC) | | | | | | | |
| PGPR | 97.00% | 3% | | | 8.70 | | 0.4% |
| | | | | | | | 100.0% |
| Nutrition: /100 g | | | | | | | |
| Energy/kJ | 993.5 | | | | | | |
| Lipid/g | 22.9 | | | | | | |
| Sat. fat/g | 7.9 | | | | | | |
| Sugar/g | 1.4 | | | | | | |
| Fiber/g | 5.9 | | | | | | |
| Protein/g | 7.3 | | | | | | |

### Example 2: Milk Confectionery Bar

The ingredients are detailed in Table 2 below.

TABLE 2

| | Ingredient values | | | | | | |
|---|---|---|---|---|---|---|---|
| | Lipid | Sat. fat | Sugar | Dietary | Energy | Protein | % ingredient |
| Ingredient | % | % | % | fiber % | (kcal/g) | % | in product |
| Maltitol | | | | | 2.40 | 0% | 34.0% |
| Erythritol | | | | | 0.00 | | 12.0% |
| Sunflower seed | 50.00% | 4.7% | 9.4% | 6.2% | 6.25 | 22% | 19.5% |
| butter | | | | | | | |
| Ultra-filtered | 1.7% | 0.9% | 4.2% | 0.4% | 3.60 | 82% | 9.0% |
| skim milk | | | | | | | |
| Cocoa liquor | 53.5% | 32.1% | 0.3% | 18.8% | 5.10 | 24% | 17.0% |
| Soy lecithin | 78.0% | 15.0% | 0.0% | 0.0% | 7.24 | 0.0% | 0.1% |
| Potato starch, | 0.1% | 0.0% | 0.0% | 74.2% | 0.40 | 0.0% | 8.0% |
| modified | | | | | | | |
| (Versafibe1490) | | | | | | | |
| PGPR | 97.0% | 3.0% | 0.0% | 0.0% | 8.70 | 0.0% | 0.4 |
| | | | | | | | 100.0% |
| Nutrition: /100 g | | | | | | | |
| Energy/kJ | 1379.4 | | | | | | |
| Lipid/g | 19.5 | | | | | | |
| Sat. fat/g | 6.5 | | | | | | |
| Sugar/g | 2.3 | | | | | | |
| Fiber/g | 10.4 | | | | | | |
| Protein/g | 13.7 | | | | | | |

### Example 3: Milk Confectionery Bar

The ingredients are detailed in Table 3 below.

TABLE 3

| | Ingredient values | | | | | | |
|---|---|---|---|---|---|---|---|
| | Lipid | Sat. fat | Sugar | Dietary | Energy | Protein | % ingredient |
| Ingredient | % | % | % | fiber % | (kcal/g) | % | in product |
| Maltitol | | | | | 2.40 | 0% | 33.0% |
| Erythritol | | | | | 0.00 | | 28.5% |
| Sunflower | 93.2% | 9.0% | | | 8.84 | | 11.7% |
| oil | | | | | | | |
| Ultra-filtered | 1.7% | 0.9% | 4.2% | 0.4% | 3.60 | 82% | 8.7% |
| skim milk | | | | | | | |
| Cocoa mass | 53.5% | 32.1% | 0.3% | 18.8% | 5.10 | 24% | 12.8% |
| Cocoa butter | 100% | 60% | | | 8.84 | | 4.1% |
| Soy lecithin | 78.0% | 15.0% | 0.0% | 0.0% | 7.24 | 0.0% | 0.8% |
| PGPR | 97.0% | 3.0% | 0.0% | 0.0% | 8.70 | 0.0% | 0.4% |
| | | | | | | | 100.0% |
| Nutrition: /100 g | | | | | | | |
| Energy/kJ | 1362.3 | | | | | | |
| Lipid/g | 23.2 | | | | | | |
| Sat. fat/g | 7.8 | | | | | | |
| Sugar/g | 0.4 | | | | | | |
| Fiber/g | 2.4 | | | | | | |
| Protein/g | 8.6 | | | | | | |

### Example 4: Dark Confectionery Bar

The ingredients are detailed in Table 4 below.

TABLE 4

| | Ingredient values | | | | | | |
|---|---|---|---|---|---|---|---|
| | Lipid | Sat. fat | Sugar | Dietary | Energy | Protein | % ingredient |
| Ingredient | % | % | % | fiber % | (kcal/g) | % | in product |
| Maltitol | | | | | 2.40 | 0% | 11.0% |
| Erythritol | | | | | 0.00 | | 21.7% |
| Soluble | | | <2% | ≥85% | 1.1 | | 8.5% |
| corn fiber | | | | | | | |
| Hazelnut | 65.1% | 4.5% | 4% | 8.8 | 6.89 | 14.8% | 20% |
| paste | | | | | | | |
| Cocoa | 1.0% | 0.6% | 0.6% | 37% | 1.32 | 25% | 10.5% |
| powder | | | | | | | |
| Cocoa | 53.5% | 32.1% | 0.3% | 18.8% | 5.10 | 24% | 21.5% |
| liquor | | | | | | | |
| Calcium | | | | | | | 6.5% |
| carbonate | | | | | | | |
| Soy lecithin | 78.0% | 15.0% | 0.0% | 0.0% | 7.24 | 0.0% | 0.2% |
| PGPR | 97.0% | 3% | 0.0% | 0.0% | 8.70 | 0.0% | 0.1% |
| | | | | | | | 100.0% |
| Nutrition: /100 g | | | | | | | |
| Energy/kJ | 1338.3 | | | | | | |
| Lipid/g | 24.9 | | | | | | |
| Sat. fat/g | 7.9 | | | | | | |
| Sugar/g | 1.1 | | | | | | |
| Fiber/g | 17 | | | | | | |
| Protein/g | 8.2 | | | | | | |

### Example 5: Dark Confectionery Bar

The ingredients are detailed in Table 5 below.

TABLE 5

| | Ingredient values | | | | | | |
|---|---|---|---|---|---|---|---|
| | Lipid | Sat. fat | Sugar | Dietary | Energy | Protein | % ingredient |
| Ingredient | % | % | % | fiber % | (kcal/g) | % | in product |
| Maltitol | | | | | 2.40 | 0% | 12.3% |
| Erythritol | | | | | 0.00 | | 20.6% |
| Soluble | | | <2% | ≥85% | 1.1 | | 8.2% |
| corn fiber | | | | | | | |
| Hazelnut | 65.7% | 7% | 4.5% | 8.2 | 6.98 | 12% | 20.0% |
| paste | | | | | | | |
| Cocoa | 1.0% | 0.6% | 0.6% | 37% | 1.32 | 25% | 12.2% |
| powder | | | | | | | |
| Cocoa | 53.5% | 32.1% | 0.3% | 18.8% | 5.10 | 24% | 19.9% |
| liquor | | | | | | | |
| Calcium | | | | | | | 6.5% |
| carbonate | | | | | | | |
| Soy lecithin | 78.0% | 15.0% | 0.0% | 0.0% | 7.24 | 0.0% | 0.2% |
| | | | | | | | 100.0% |
| Nutrition: /100 g | | | | | | | |
| Energy/kJ | 1339.1 | | | | | | |
| Lipid/g | 24.2 | | | | | | |
| Sat. fat/g | 7.9 | | | | | | |
| Sugar/g | 1.2 | | | | | | |
| Fiber/g | 16.9 | | | | | | |
| Protein/g | 7.9 | | | | | | |

### Example 6: Milk Confectionery Bar

The ingredients are detailed in Table 6 below.

TABLE 6

| | Ingredient values | | | | | | |
|---|---|---|---|---|---|---|---|
| | Lipid | Sat. fat | Sugar | Dietary | Energy | Protein | % ingredient |
| Ingredient | % | % | % | fiber % | (kcal/g) | % | in product |
| Sucrose | | | 100% | | 3.87 | | 5.9% |
| Maltitol | | | | | 2.40 | 0% | 39.3% |
| Erythritol | | | | | 0.00 | | 20.2% |
| Hazelnut | 65.1% | 4.5% | 4% | | 6.89 | 14.8% | 9.4% |
| paste | | | | | | | |
| Non fat dry | 53.1% | 0.5% | 52.0% | | 5.94 | 24% | 5.0% |
| milk powder | | | | | | | |
| Shea butter | 100% | 47% | | | 8.84 | | 10.3% |
| Rapeseed oil | 100% | 7.4% | | | 8.84 | | 3.5% |
| Cocoa | 1.0% | 0.6% | 0.6% | 37% | 1.32 | 25% | 5.3% |
| powder | | | | | | | |
| Soy lecithin | 78.0% | 15.0% | 0.0% | 0.0% | 7.24 | 0.0% | 0.8% |
| PGPR | 97.0% | 3.0% | 0.0% | 0.0% | 8.70 | 0.0% | 0.4% |
| | | | | | | | 100.0% |
| Nutrition: /100 g | | | | | | | |
| Energy/kJ | 1414.8 | | | | | | |
| Lipid/g | 20.8 | | | | | | |
| Sat. fat/g | 5.9 | | | | | | |
| Sugar/g | 8.9 | | | | | | |
| Fiber/g | 2.7 | | | | | | |
| Protein/g | 4.3 | | | | | | |

### Example 7: Dark Confectionery Bar

The ingredients are detailed in Table 7 below.

TABLE 7

| | Ingredient values | | | | | | |
|---|---|---|---|---|---|---|---|
| | Lipid | Sat. fat | Sugar | Dietary | Energy | Protein | % ingredient |
| Ingredient | % | % | % | fiber % | (kcal/g) | % | in product |
| Erythritol | | | | | 0.00 | | 50.0% |
| Hazelnut | 65.1% | 4.5% | 4% | | 6.89 | 14.8% | 14.0% |
| paste | | | | | | | |
| Cocoa | 1.0% | 0.6% | 0.6% | 37% | 1.32 | 25% | 3.5% |
| powder | | | | | | | |
| Cocoa | 53.5% | 32.1% | 0.3% | 18.8% | 5.10 | 24% | 25.3% |
| liquor | | | | | | | |
| Calcium | | | | | | | 6.5% |
| carbonate | | | | | | | |
| Soy lecithin | 78.0% | 15.0% | 0.0% | 0.0% | 7.24 | 0.0% | 0.2% |
| PGPR | 97.0% | 3.0% | | | 8.70 | | 0.5% |
| | | | | | | | 100.0% |
| Nutrition: /100 g | | | | | | | |
| Energy/kJ | 1002 | | | | | | |
| Lipid/g | 23.3 | | | | | | |
| Sat. fat/g | 8.8 | | | | | | |
| Sugar/g | 0.7 | | | | | | |
| Fiber/g | 7.3 | | | | | | |
| Protein/g | 6 | | | | | | |

The above embodiments are described by way of example only. Many variations are possible without departing from the scope of the invention as defined in the appended claims.

1. A chocolate product comprising >18 wt. % natural lipid, >10 wt. % sugar and/or sugar replacer, and >5 wt. % of at least one cocoa ingredient selected from the group comprising: cocoa butter, cocoa liquor, cocoa powder, cocoa pulp, and combinations thereof, wherein at least one of the following conditions is satisfied:
a. The product comprises more than 8 wt. % and no more than 9 wt. % saturated fat and ≤2.5 wt. % sugar;
b. The product comprises more than 6 wt. % and no more than 8 wt. % saturated fat and ≤4.5 wt. % sugar;
c. The product comprises more than 5 wt. % and no more than 6 wt. % saturated fat and ≤9 wt. % sugar;
d. The product comprises more than 4 wt. % and no more than 5 wt. % saturated fat and ≤13.5 wt. % sugar;
e. The product comprises more than 3 wt. % and no more than 4 wt. % saturated fat and ≤18 wt. % sugar;
f. The product comprises more than 2 wt. % and no more than 3 wt. % saturated fat and ≤22.5 wt. % sugar; or
g. The product comprises less than or equal to 2 wt. % saturated fat and ≤27 wt. % sugar;
and wherein when the product satisfying any of conditions a-g comprises ≤10 wt. % sugar, the remainder of the total combined sugar and sugar replacer content is made up to >10 wt % with sugar replacer.

2. A chocolate product as claimed in claim 1, wherein the product is a non-powder solid at 25° C. and ambient pressure.

3. A chocolate product as claimed in claim 1, wherein the product contains no non-chocolate solid inclusions having a largest dimension of greater than 1 mm.

4. A chocolate product as claimed in claim 1, wherein at least one of the following conditions is satisfied:
h. The product comprises more than 7 wt % and no more than 8 wt % saturated fat and <1340 kJ per 100 g;
i. The product comprises more than 6 wt % and no more than 7 wt % saturated fat and <1675 kJ per 100 g;
j. The product comprises more than 5 wt % and no more than 6 wt % saturated fat and <2010 kJ per 100 g;
k. The product comprises more than 4 wt % and no more than 5 wt % saturated fat and <2345 kJ per 100 g;
l. The product comprises less than or equal to 4 wt % saturated fat and <2680 kJ per 100 g.

5. A chocolate product as claimed in claim 1, wherein the product comprises at least one sugar alcohol in an amount of 10-50 wt %.

6. A chocolate product as claimed in claim 1, wherein the product comprises <3 wt % sugar.

7. A chocolate product as claimed in claim 1, wherein the chocolate product comprises sugar and the ratio of the amount of sugar replacer to sugar is between 15:1 and 90:1.

8. A chocolate product as claimed in claim 1, wherein the product comprises between 18-35 wt % natural lipid, or between 18-25 wt % natural lipid.

9. A chocolate product as claimed in claim 1, wherein the product comprises at least one natural lipid ingredient selected from the group comprising: cocoa butter, a nut butter, a seed butter, a nut oil, a seed oil, and combinations thereof.

10. A chocolate product as claimed in claim 9, wherein the product comprises between 18-35 wt %, and preferably 18-25 wt % of the at least one natural lipid ingredient selected from the group comprising: cocoa butter, a nut butter, a seed butter, a nut oil, a seed oil, and combinations thereof.

11. A chocolate product as claimed in claim 9, wherein the product comprises at least one natural lipid ingredient independently selected from the group comprising: a nut butter, a seed butter, a nut oil, a seed oil, and combinations thereof in a total amount of 0.2-25 wt %.

12. A chocolate product as claimed in claim 1, wherein the product comprises at least one natural wax.

13. A chocolate product as claimed in claim 1 which comprises sugar, wherein the sugar comprises at least one monosaccharide or disaccharide selected from the group comprising glucose, fructose, galactose, sucrose, lactose, maltose, and sugar hydrates.

14. A chocolate product as claimed in claim 1 wherein the sugar replacer comprises at least one ingredient selected from the group comprising oligosaccharides; polysaccharides; sugar alcohols; non-nutritive monosaccharides and disaccharides with an energy content of ≤3 kcal/g; dietary fiber (insoluble or soluble); resistant starches and flours containing resistant starches; and combinations thereof.

15. A chocolate product as claimed in claim 1, wherein the product contains a single cocoa-containing ingredient.

16. A chocolate product as claimed in claim 1, wherein the product comprises in total less than or equal to 20 wt. %, and preferably less than or equal to 18 wt. %, of the following cocoa ingredients: cocoa butter, cocoa liquor, and cocoa powder.

17. A method of preparing a chocolate product according to claim 1, wherein the method comprises the step of combining natural lipid, sugar and/or sugar replacer, and at least one cocoa ingredient selected from the group comprising: cocoa butter, cocoa liquor, cocoa powder, cocoa pulp, and combinations thereof.
